(19) United States
(12) Patent Application Publication
(10) Pub. No.: US 2012/0190493 A1
(43) Pub. Date: Jul. 26, 2012

(54) COUPLING DEVICE

(75) Inventor: Hideki TAMOTO, Toyota-shi (JP)

(73) Assignee: TOYOTA JIDOSHA KABUSHIKI KAISHA, Toyota-shi (JP)

(21) Appl. No.: 13/334,989

(22) Filed: Dec. 22, 2011

(30) Foreign Application Priority Data
Jan. 26, 2011 (JP) 2011-013797

(51) Int. Cl. F16H 48/26; F16D 25/12

(52) U.S. Cl. 475/87; 192/85.01

(57) ABSTRACT

A coupling device includes a clutch mechanism portion that is provided between a propeller shaft and a drive pinion shaft, and that engages by viscous resistance of hydraulic fluid. This coupling device is able to transmit driving force from a driving source to the drive pinion shaft by the engagement of this clutch mechanism portion. Also, an oil pump is provided that supplies hydraulic fluid not used for engaging the clutch mechanism portion to the clutch mechanism portion when the drive pinion shaft rotates.

### INCORPORATION BY REFERENCE

The disclosure of Japanese Patent Application No. 2010-013797 filed on Jan. 26, 2011 including the specification, drawings and abstract is incorporated herein by reference in its entirety.

### BACKGROUND OF THE INVENTION

1. Field of the Invention

The invention relates to a coupling device capable of transmitting driving force from a driving source to a rear-wheel side rotating shaft in a four-wheel-drive vehicle.

2. Description of the Related Art

In a four-wheel-drive vehicle, a coupling device (such as an electronically controlled coupling) provided between a front-wheel side rotating shaft and a rear-wheel side rotating shaft is used to switch between a two-wheel drive state and a four-wheel-drive state, as well as to change the front-rear torque distribution when in the four-wheel-drive state. The coupling device includes a wet type frictional engagement portion that engages by viscous resistance of hydraulic fluid, for example. The coupling device is able to transmit driving force from a driving source to the rear-wheel side rotating shaft from the front-wheel side rotating shaft by engagement of the wet type frictional engagement portion.

As related art, Japanese Patent Application Publication No. 05-018426 (JP-A-05-018426), for example, proposes a coupling device that, when there is a difference in rotation speed between a front-wheel side rotating shaft and a rear-wheel side rotating shaft, synchronizes the rotation of the front-wheel side rotating shaft and the rear-wheel side rotating shaft by engaging the wet type frictional engagement portion (i.e., a multiple disc clutch mechanism), and circulates hydraulic fluid by operating an oil pump.

When a vehicle is being towed in a state which only the rear wheels are in contact with the ground and the engine is stopped (so-called two-wheel towing), only the rear-wheel side rotating shaft rotates, which results in there being a large difference in rotation speed between the front-wheel side rotating shaft and the rear-wheel side rotating shaft. However, the related art described above does not take a scenario in which the vehicle is being towed into account, so the wet type frictional engagement portion ends up engaging even when the vehicle is being towed, and as a result, an excessive amount of heat may be generated in coupling device.

### SUMMARY OF THE INVENTION

The invention provides a coupling device capable of obtaining a cooling effect by supplying hydraulic fluid to a wet type frictional engagement portion when a rear-wheel side rotating shaft is rotated at times such as when a vehicle is being towed.

Thus, a first aspect of the invention relates to a coupling device that includes a wet type frictional engagement portion and an oil pump. The wet type frictional engagement portion is provided between a front-wheel side rotating shaft and a rear-wheel side rotating shaft, and that engages by viscous resistance of hydraulic fluid, and transmits driving force from a driving source to the rear-wheel side rotating shaft by this engagement. The oil pump supplies hydraulic fluid not used for engaging the wet type frictional engagement portion to the wet type frictional engagement portion when the rear-wheel side rotating shaft rotates. Here, the wet type frictional engagement portion engages by the viscous resistance of hydraulic fluid, and hydraulic fluid that is forcibly circulated through the coupling device by the oil pump without contributing much at all to that engagement is the “hydraulic fluid not used for engaging”. A trochoid oil pump that creates a pumping action by relative rotation of an inner rotor and an outer rotor, for example, may be used as the oil pump.

According to the coupling device having the structure described above, when the vehicle is towed with only the rear wheels contacting the ground and the engine stopped, a difference in rotation speed occurs between the front-wheel side rotating shaft and the rear-wheel side rotating shaft. However, hydraulic fluid not used for engaging the wet type frictional engagement portion is supplied to the wet type frictional engagement portion by the pumping action of the oil pump that is created when the drive pinion shaft rotates, which differs from the related art. Therefore, when the rear-wheel side rotating shaft rotates at times such as when the vehicle is being towed, for example, the wet type frictional engagement portion is able to be lubricated and cooled by the hydraulic fluid supplied by the oil pump.

In the coupling device described above, the oil pump may be mounted on the rear-wheel side rotating shaft.

According to this structure, the oil pump is directly driven by the rotation of the rear-wheel side rotating shaft, even if electric power is not supplied, so there is no longer a need to newly provide a rotating member that rotates with the rotation of the rear-wheel side rotating shaft, thereby enabling the structure to be simplified.

Also, in the coupling device described above, a gear provided on the rear-wheel side rotating shaft may be in mesh with a gear provided on a counter shaft that is arranged parallel to the rear-wheel side rotating shaft, and the oil pump may be mounted on the counter shaft.

According to this structure, the oil pump is not driven directly by the rear-wheel side rotating shaft. Instead, the rotation of the rear-wheel side rotating shaft is transmitted via the counter shaft to drive the oil pump. Therefore, the oil pump can be driven, even if no electric power is supplied, when the rear-wheel side rotating shaft rotates. Also, the degree of freedom with respect to the location where the oil pump is arranged can be improved.

Also, in the coupling device described above, the oil pump may be mounted on a non-rotating portion of the coupling device.

According to this structure, when the rear-wheel side rotating shaft rotates, a difference in rotation speed occurs between the rear-wheel side rotating shaft and the non-rotating portion, so the oil pump is driven regardless of a difference in rotation speed between the front-wheel side rotating shaft and the rear-wheel side rotating shaft. As a result, when the rear-wheel side rotating shaft rotates, the oil pump is always driven, so the wet type frictional engagement portion can always be lubricated and cooled.

Also, in the coupling device described above, the oil pump may be arranged between the coupling device and a differential device that performs a differential operation between a pair of left and right rear wheels.

According to this structure, heat exchange can be performed between the coupling device and the differential device by the hydraulic fluid that is forcibly delivered by the oil pump when the rear-wheel side rotating shaft rotates. Also, when the vehicle is being towed, cooling of the wet type frictional engagement portion can be promoted, so an increase in the temperature of the wet type frictional engagement portion can be suppressed.

According to the coupling device of the invention, it is possible to lubricate and cool a wet type frictional engagement portion with hydraulic fluid supplied by an oil pump, when a rear-wheel side rotating shaft is rotated at times such as when a vehicle is being towed.

### BRIEF DESCRIPTION OF THE DRAWINGS

The features, advantages, and technical and industrial significance of this invention will be described in the following detailed description of example embodiments of the invention with reference to the accompanying drawings, in which like numerals denote like elements, and wherein:

FIG. 1 is a view showing a frame format of an example of a four-wheel-drive vehicle provided with a coupling device according to an example embodiment of the invention;

FIG. 2 is a sectional view of an electronically controlled coupling and a rear differential provided in the four-wheel-drive vehicle shown in FIG. 1; and

FIG. 3 is a sectional view of the electronically controlled coupling shown in FIG. 2.

### DETAILED DESCRIPTION OF EMBODIMENTS

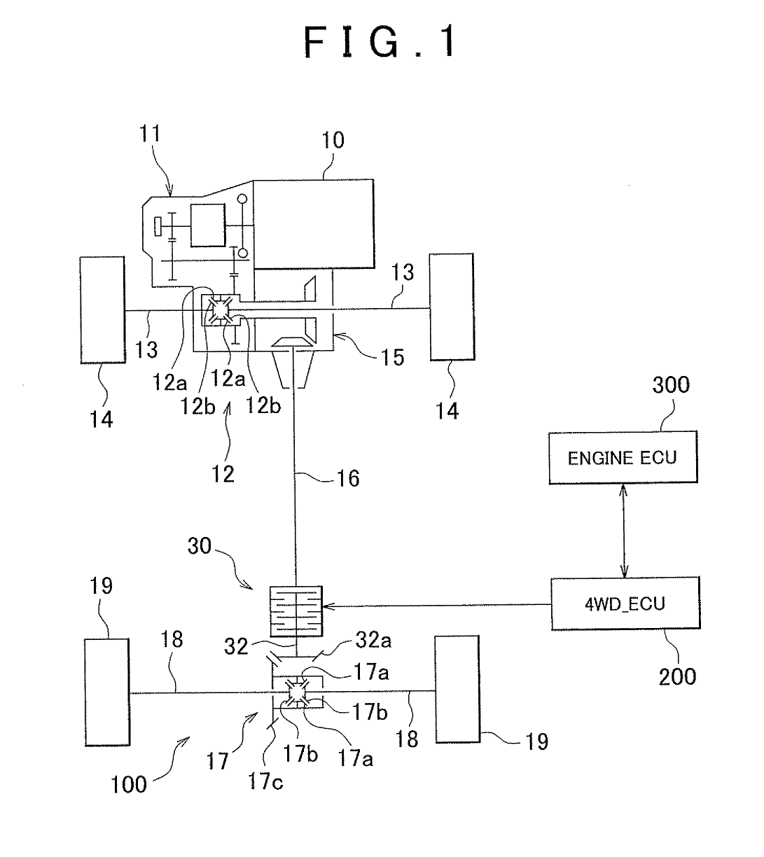

Example embodiments that carry out the invention will now be described with reference to the accompanying drawings. First, the general outline of a four-wheel-drive vehicle provided with a coupling device according to an example embodiment of the invention will be described with reference to FIG. 1. FIG. 1 is a view showing a frame format of an example of a four-wheel-drive vehicle 100 provided with a coupling device according to an example embodiment of the invention. The example of the four-wheel-drive vehicle 100 shown in FIG. 1 has a front-wheel-drive base (FF base).

As shown in FIG. 1, an engine 10 that serves as a driving source is arranged at the front (i.e., the upper side in FIG. 1) of the vehicle. The engine 10 is connected to a transmission (such as an automatic transmission) 11, and the transmission 11 is connected to a front differential 12.

A pair of left and right front wheels 14 that serve as main driving wheels (i.e., driving wheels to which driving force from the driving source is directly transmitted without passing through a coupling device) are arranged at the front near the engine 10. The left and right front wheels 14 are connected together via the front differential 12. The left and right front wheels 14 are each connected to the front differential 12 by an axle shaft 13. Driving force from the engine 10 is changed in speed by the transmission 11 and transmitted to the front differential 12, such that the front wheels 14 are driven. The front differential 12 may have any structure as long as it is capable of performing a differential operation that differentially distributes torque to the left and right front wheels 14. In the example shown in FIG. 1, the front differential 12 has a pair of pinion gears 12a and a pair of side gears 12b that rotate while in mesh with each other.

The front differential 12 is connected to a transfer 15, and the transfer 15 is connected to a propeller shaft (i.e., a front-wheel side rotating shaft) 16 that extends toward the rear of the vehicle (i.e., the lower side in FIG. 1). This transfer 15 enables the driving force of the engine 10 to be sent to the rear of the vehicle as well.

A pair of left and right rear wheels 19 that are driven wheels (i.e., driven wheels to which driving force from the driving source is transmitted via a coupling device) is arranged at the rear of the vehicle. The left and right rear wheels 19 are connected together via a rear differential 17. The left and right rear wheels 19 are each connected to the rear differential 17 by an axle shaft 18. The rear differential 17 may have any structure as long as it is capable of performing a differential operation that differentially distributes torque to the left and right rear wheels 19. In the example shown in FIG. 1, the rear differential 17 has a pair of pinion gears 17a and a pair of side gears 17b that rotate while in mesh with each other.

An electronically controlled coupling 30 that serves as a coupling device is provided between the propeller shaft 16 and the rear differential 17. In this example embodiment, the electronically controlled coupling 30 is arranged right in front of the rear differential 17. The electronically controlled coupling 30 and the rear differential 17 are provided together as a single assembly.

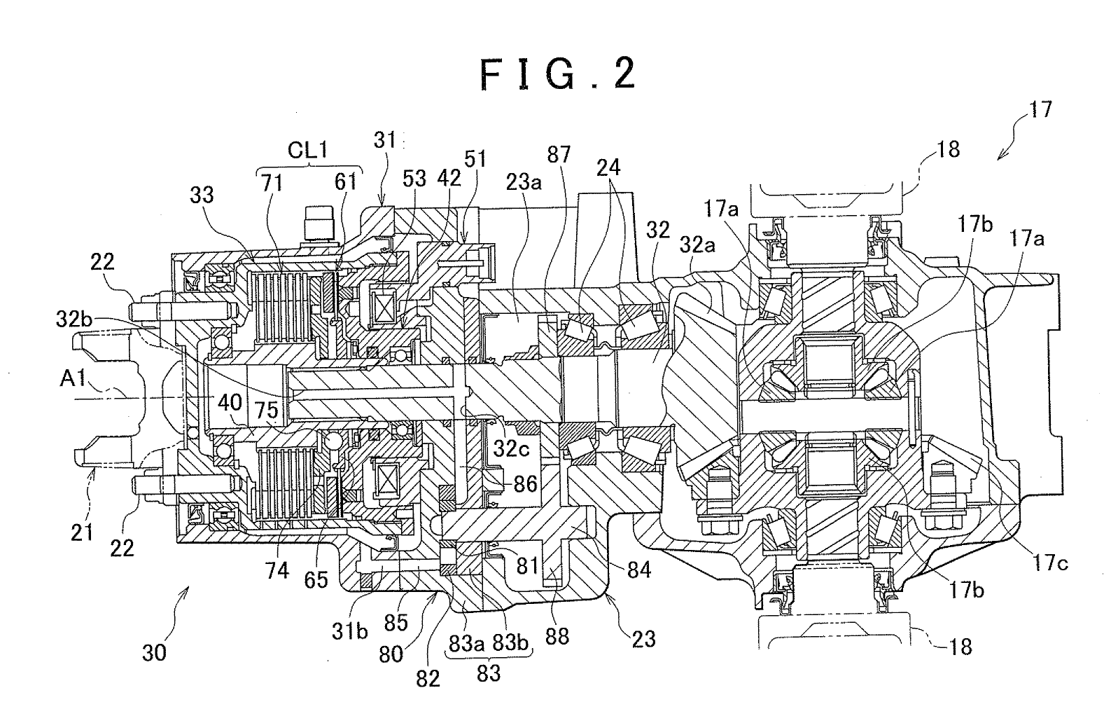

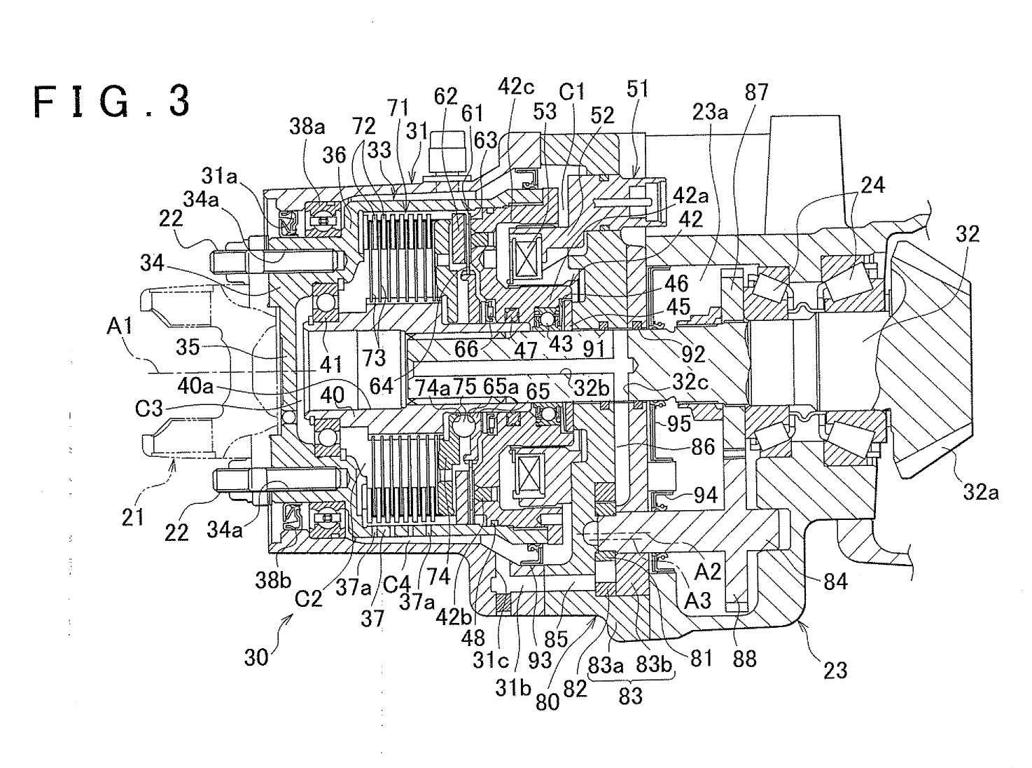

The electronically controlled coupling 30 includes an electromagnet 51 (see FIGS. 2 and 3). Transfer torque that is transmitted to the rear-wheel side is controlled by controlling the energization of this electromagnet 51. Thus, in the four-wheel-drive vehicle 100, it is possible to switch between a two-wheel-drive state and a four-wheel-drive state, as well as change the front-rear torque distribution when in the four-wheel-drive state. The electromagnet 51 is connected to a 4WD electronic control unit (4WD ECU) 200 that serves as a control apparatus. Current corresponding to the transfer torque is supplied to the electromagnet 51 (i.e., a coil 53) when necessary by the 4WD ECU 200.

The 4WD ECU 200 includes a CPU (Central Processing Unit), ROM (Read Only Memory), and RAM (Random Access Memory), and the like. Various control programs, as well as maps and the like that are referenced when executing these various control programs, are stored in the ROM. The CPU performs various calculations based on the various control programs and maps stored in the ROM. The RAM is memory in which the calculation results of the CPU and data and the like that is input from various sensors are temporarily stored.

The 4WD ECU 200 executes energization control of the electromagnet 51 of the electronically controlled coupling 30, based on detection signals and the like from various sensors and the like. More specifically, when the electromagnet 51 is de-energized, torque is not transmitted to the rear-wheel side by the electronically controlled coupling 30. At this time, the four-wheel-drive vehicle 100 is switched to the two-wheel-drive state. On the other hand, when the electromagnet 51 is energized, torque corresponding to the energization amount is transmitted to the rear-wheel side by the electronically controlled coupling 30. For example, the transfer torque increases as the value of the current (i.e., the control current value) supplied to the electromagnet 51 increases. As a result, the four-wheel-drive vehicle 100 is switched to the four-wheel-drive state.

The 4WD ECU 200 is connected to an engine ECU 300 that performs various controls of the engine 10. The 4WD ECU 200 and the engine ECU 300 are connected together so as to be able to send and receive necessary information related to control of the electronically controlled coupling 30 and control of the engine 10 back and forth. The engine ECU 300 includes a CPU, ROM, and RAM and the like, similar to the 4WD ECU 200.

Next, the specific structure of the electronically controlled coupling 30 will be described with reference to FIGS. 2 and 3. FIG. 2 is a sectional view Of the electronically controlled coupling 30 and the rear differential 17 provided in the four-wheel-drive vehicle 100 shown in FIG. 1. FIG. 3 is a sectional view of the electronically controlled coupling 30 shown in FIG. 2.

As shown in FIGS. 2 and 3, a drive pinion shaft (i.e., a rear-wheel side rotating shaft) 32 that rotates about a rotational center A1 is arranged bridging between the inside of a cover 31 of the electronically controlled coupling 30 and the inside of a differential carrier 23 of the rear differential 17. Bearings (i.e., tapered roller bearings) 24 are fitted on the inner periphery of the differential carrier 23. The drive pinion shaft 32 is rotatably supported by these bearings 24. A drive pinion gear 32a is provided on one end (i.e., the right end in FIGS. 2 and 3) of the drive pinion shaft 32. This drive pinion gear 32a is in mesh with a ring gear 17c of the rear differential 17.

An axial hole 32b and a radial hole 32c are formed inside the drive pinion shaft 32. The axial hole 32b is formed in a center portion of the drive pinion shaft 32, and extends in the axial direction from the other end (i.e., the left end in FIGS. 2 and 3) of the drive pinion shaft 32. The other end of the axial hole 32b opens on the other end of the drive pinion shaft 32. One end of the axial hole 32b reaches a position that overlaps in the axial direction with an oil pump 80 that will be described later. The radial hole 32c extends toward the outside in the radial direction from one end portion of the axial hole 32b. In this case, a plurality (such as four in this example) of radial holes 32c extend in a radial fashion from the center portion of the drive pinion shaft 32. The radial holes 32c are open on the outer periphery of the drive pinion shaft 32, and are able to communicate with a discharge chamber 86 of the oil pump 80.

The cover 31 of the electronically controlled coupling 30, a pump housing 83 of the oil pump 80, and the differential carrier 23 are all arranged lined up in the axial direction. These members 31, 83, and 23 are integrally provided and are thus unable to rotate relative to one another. The cover 31 is formed in a cylindrical shape, and a cylindrical front housing 33 with one end closed is arranged in the space inside the cover 31. An oil reservoir 31b and a communication hole 31c are formed in one end portion (i.e., the right end portion in FIGS. 2 and 3) of the cover 31. The oil reservoir 31b is communicated with an intake chamber 85 of the oil pump 80. The oil reservoir 31b is also communicated with a space C4 between the front housing 33 and the cover 31 via the communication hole 31c.

The front housing 33 is made of nonmagnetic material such as aluminum. The front housing 33 has a small diameter cylindrical portion 34, a bottom portion 35, an annular connecting portion 36, and a large diameter cylindrical portion 37. The small diameter cylindrical portion 34 is arranged in an open portion 31a of the cover 31, and an outside end portion of the cover 31 at the small diameter cylindrical portion 34 is closed off by a bottom portion 35. The connecting portion 36 extends out toward the outer peripheral side from an inside end portion of the cover 31 at the small diameter cylindrical portion 34. The large diameter cylindrical portion 37 is arranged toward the differential carrier 23 side (i.e., the right side in FIGS. 2 and 3) from the outer peripheral end of the connecting portion 36. A bearing 38a and an oil seal 38b are fixed to the inner periphery of the end portion of the cover 31 on the open portion 31a side. An inner race of the bearing 38a is mounted on the outer periphery of the small diameter cylindrical portion 34 of the front housing 33.

A flange 21 is attached to the end surface of the small diameter cylindrical portion 34 of the front housing 33 that is toward the outside of the cover 31. The front housing 33 and the flange 21 are fixed by a stud bolt 22. This stud bolt 22 is screwed into a female screw portion 34a formed in the small diameter cylindrical portion 34. The flange 21 is connected to the propeller shaft 16 (see FIG. 1).

A hollow inner shaft 40 that rotates about the rotational center A1 is arranged inside of the cover 31. This inner shaft 40 is a rotating member that is able to rotate when a clutch mechanism portion (i.e., a wet type frictional engagement portion) CL1 that will be described later is engaged, and is unable to rotate when the clutch mechanism portion CL1 is released. A bearing 41 is fitted between the inner periphery of the small diameter cylindrical portion 34 and the outer periphery of the end portion of the inner shaft 40 that is on the small diameter cylindrical portion 34 side, such that the inner shaft 40 is rotatably supported by the bearing 41. The other end portion (i.e., the left end portion in FIGS. 2 and 3) of the drive pinion shaft 32 is spline-engaged with the inside the inner shaft 40, such that the inner shaft 40 and the drive pinion shaft 32 rotate together. Also, the axial hole 32b of the drive pinion shaft 32 is communicated with an internal space 40a of the inner shaft 40, and the internal space 40a of the inner shaft 40 is communicated with a space C3 between the inner shaft 40 and the front housing 33.

An annular rear housing 42 that can rotate about the rotational center A1 is arranged on the peripheral outside of the inner shaft 40. This rear housing 42 is formed by an inner cylindrical portion 42a that has a generally L-shaped cross-section in the radial direction, an annular interrupting member 42b that is fixed to the outer periphery of the inner cylindrical portion 42a, and an outer cylinder portion 42c that is fixed to the outer periphery of the interrupting member 42b. The inner cylindrical portion 42a and the outer cylinder portion 42c are made of magnetic material such as iron, for example, and the interrupting member 42b is made of nonmagnetic material. The outer cylinder portion 42c is screw-connected to the inner periphery of the front housing 33, and fixed to the front housing 33 so as not to be able to rotate relative thereto by welding. Therefore, the front housing 33 and the rear housing 42 rotate together.

Also, a bearing 43 is fitted between the inner periphery of the inner cylindrical portion 42a and the outer periphery of the drive pinion shaft 32, such that the rear housing 42 is provided so as to be able to rotate relative to the inner shaft 40 by the bearing 43. An annular shim 45 that adjusts the gap in the axial direction, and an annular belleville spring 46 are provided between the bearing 43 and a pump housing 83 that will be described later.

A seal ring (such as an X-ring) 47 is fitted between the inner periphery of the inner cylindrical portion 42a and the outer periphery of the inner shaft 40. This seal ring 47 provides a liquid-tight seal between the inner shaft 40 and the rear housing 42. A seal ring (such as an O-ring) 48 is fitted between the outer periphery of the outer cylinder portion 42c and the inner periphery of the front housing 33. This seal ring 48 provides a liquid-tight seal between the rear housing 42 and the front housing 33.

The space surrounded by the differential carrier 23, the rear housing 42, and the pump housing 83 is an electromagnet housing chamber C1. This electromagnet housing chamber C1 is sealed in a liquid- and gas-tight manner from the surrounding space. The electromagnet 51 is arranged in the electromagnet housing chamber C1. This electromagnet 51 includes an annular iron core 52 made of magnetic material, and a coil 53 wound around the iron core 52. The iron core 52 is provided so as not to be able to rotate with respect to the cover 31. The coil 53 is connected to the 4WD ECU 200 (see FIG. 1) via an electrical wire.

The space surrounded by the front housing 33, the inner shaft 40, and the rear housing 42 is a clutch mechanism housing chamber C2. The clutch mechanism portion CL1 is arranged in this clutch mechanism housing chamber C2. The clutch mechanism portion CL1 includes a pilot clutch 61 that engages and releases according to the electromagnetic force of the electromagnet 51, and a main clutch 71 that engages and releases in conjunction with the engagement and release operation of the pilot clutch 61. Also, hydraulic fluid (i.e., coupling oil) is able to flow to the clutch mechanism housing chamber C2. The pilot clutch 61 and the main clutch 71 engage by the viscous resistance of the hydraulic fluid supplied to the clutch mechanism housing chamber C2. Hydraulic fluid is supplied to the clutch mechanism housing chamber C2 through an oil circulation path. The oil circulation path formed in the electronically controlled coupling 30 will be described in detail later.

The pilot clutch 61 includes an armature 62, a clutch disc 63, and a clutch plate 64. The armature 62 is arranged a predetermined distance in the axial direction from the rear housing 42. The clutch disc 63 and the clutch plate 64 are arranged between the armature 62 and the rear housing 42. The armature 62 and the clutch disc 63 are spline-engaged with the inner periphery of the front housing 33.

An annular cam 65 is mounted on the outer periphery of the inner shaft 40. The cam 65 is provided so as to be able to rotate relative to the inner shaft 40. The clutch plate 64 is spline-engaged with the outer periphery of this cam 65. Also, a thrust bearing 66 is provided between the cam 65 and the inner cylindrical portion 42a of the rear housing 42. This thrust bearing 66 is provided to take (i.e., receive) the thrust load applied to the cam 65, and to enable the rear housing 42 and the cam 65 to be able to rotate relative to each other.

The main clutch 71 is arranged between the pilot clutch 61 and the small diameter cylindrical portion 34 of the front housing 33. This main clutch 71 includes a plurality of clutch discs 72, and a plurality of clutch plates 73. The clutch discs 72 and the clutch plates 73 are arranged alternately. The clutch discs 72 are spline-engaged with the inner periphery of the large diameter cylindrical portion 37 of the front housing 33, and the clutch plates 73 are spline-engaged with the outer periphery of the inner shaft 40. Also, a plurality of communication holes 37a are formed in the large diameter cylindrical portion 37 of the front housing 33. These communication holes 37a are formed lined up at predetermined intervals in the axial and circumferential directions. The communication holes 37a provide communication between the clutch mechanism housing chamber C2 and a space C4 between the front housing 33 and the cover 31. That is, the clutch mechanism housing chamber C2 is not sealed in a liquid- and gas-tight manner from the surrounding space, but is instead open to the surrounding space via the communication holes 37a.

An annular piston 74 is arranged between the main clutch 71 and the pilot clutch 61. This piston 74 is spline-engaged with the outer periphery of the inner shaft 40. A plurality of concave portions 74a and 65a corresponding to cam surfaces are formed on sides of the piston 74 and the cam 65, respectively, that face one another. A plurality of balls 75 (only one is shown in FIGS. 2 and 3) are provided fit into the concave portions 74a and 65a, between the piston 74 and the cam 65.

Next, the operation of the electronically controlled coupling 30 having the structure described above will be described. First, when current is not being supplied to the electromagnet 51 of the electronically controlled coupling 30, the pilot clutch 61 and the main clutch 71 are released. Therefore, torque transmitted from the propeller shaft 16 to the front housing 33 is not transmitted to the inner shaft 40 and the drive pinion shaft 32. In this case, the four-wheel-drive vehicle 100 is in the two-wheel-drive state.

On the other hand, when current is supplied to the electromagnet 51, magnetic flux passes through the iron core 52, the outer cylinder portion 42c, the armature 62, and the inner cylindrical portion 42a, such that a magnetic circuit is formed. Accordingly, the armature 62 moves to the outer cylinder portion 42c and the inner cylindrical portion 42a side by the electromagnetic force (i.e., magnetic attractive force). Thus, the clutch disc 63 and the clutch plate 64 of the pilot clutch 61 engage. That is, the pilot clutch 61 engages. As a result, the torque of the front housing 33 is transmitted to the cam 65 via the pilot clutch 61.

When torque is transmitted to the cam 65, the cam 65 and the piston 74 rotate relative to each other. When this happens, force that tries to push the balls 75 to the outside of the concave portions 65a and 74a of the cam 65 and the piston 74 is applied such that a thrust load is generated in a direction in which the cam 65 and the piston 74 move away from each other in the axial direction. In this case, the cam 65 is received (i.e., stopped) by the thrust bearing 66 and is thus prevented from moving to the rear housing 42 side. Therefore, the piston 74 is pushed to the main clutch 71 side by this thrust load, such that the clutch discs 72 and the clutch plates 73 engage. In this case, the engaging force of the pilot clutch 61 is multiplied by the cam 65, the balls 75, and the piston 74, and then transmitted to the main clutch 71. When the main clutch 71 engages, the torque transmitted from the propeller shaft 16 to the front housing 33 is transmitted to the inner shaft 40 and the drive pinion shaft 32 via the main clutch 71. As a result, the four-wheel-drive vehicle 100 is placed in the four-wheel-drive state. In this case, as the value of the current flowing to the electromagnet 51 increases, the engaging force of the main clutch 71, and thus the torque transmitted to the drive pinion shaft 32, also increases. When the current flowing to the electromagnet 51 becomes equal to or greater than a predetermined value, torque is transmitted to the drive pinion shaft 32 in a state near a lock-up state.

### Characteristic Portion of the Example Embodiment

In this example embodiment, the electronically controlled coupling 30 having the structure described above is characterized by including the oil pump 80 that supplies the clutch mechanism portion CL1 with hydraulic fluid not used to engage the clutch mechanism portion (i.e., the wet type frictional engagement portion) CL1 when the drive pinion shaft 32 that is the rear-wheel side rotating shaft is rotating. Hereinafter, the characteristic portion of this example embodiment will be described in detail with reference to FIGS. 2 and 3.

As shown in FIGS. 2 and 3, the oil pump 80 is a trochoid oil pump that creates a pumping action by a change in volume between teeth (hereinafter, simply referred to as the “inter-teeth volume”) from relative rotation of an inner rotor 81 and an outer rotor 82, for example. More specifically, the oil pump 80 is formed by the inner rotor 81, the outer rotor 82, and the pump housing 83, and the like.

The inner rotor 81 has a plurality (such as four) external teeth. A counter shaft (i.e., a transmitting shaft) 84 that extends parallel to the drive pinion shaft 32 is spline-engaged with the center portion of the inner rotor 81, such that the counter shaft 84 rotates together with the inner rotor 81. The inner rotor 81 is able to rotate about a rotational center A2. The outer rotor 82 has a larger number (such as five) of internal teeth than the inner rotor 81 has external teeth. The outer rotor 82 is rotatably housed in the pump housing 83 and is centered on a rotational center A3. The outer rotor 82 is offset by a predetermined amount with respect to the inner rotor 81, and the internal teeth of the outer rotor 82 are provided in mesh with the external teeth of the inner rotor 81.

Also, when the inner rotor 81 rotates following rotation of the counter shaft 84, the outer rotor 82 that is in mesh with this inner rotor 81 also rotates in the same direction inside the pump housing 83. At this time, the inter-teeth volume of the inner rotor 81 and the outer rotor 82 continuously (i.e., smoothly) changes from the relative rotation of the inner rotor 81 and the outer rotor 82.

The pump housing 83 is fixed between the cover 31 and the differential carrier 23, and is unable to rotate relative to the cover 31. The pump housing 83 has a split structure (i.e., a two-piece construction) of housing main body 83a and a housing cover 83b that is attached by bolts or the like to this housing main body 83a. An intake chamber 85 that draws in hydraulic fluid that flows through an oil circulation path, that will be described later, is formed in the housing main body 83a. The intake chamber 85 is formed in a region where the inter-teeth volume of the inner rotor 81 and the outer rotor 82 is increased. The intake chamber 85 is communicated with the oil reservoir 31b formed inside the cower 31. The oil reservoir 31b is a space in which hydraulic fluid is stored. Providing the oil reservoir 31b makes it possible to increase the amount of hydraulic fluid that circulates through the oil circulation path.

Also, a discharge chamber 86 that discharges hydraulic fluid into the oil circulation path is formed by the housing main body 83a and the housing cover 83b. The discharge chamber 86 is formed in a region where the inter-teeth volume of the inner rotor 81 and the outer rotor 82 is reduced. The discharge chamber 86 is able to be communicated with the radial holes 32c formed in the drive pinion shaft 32. That is, the positions of the openings of the radial holes 32c change as the drive pinion shaft 32 rotates, so the radial holes 32c and the discharge chamber 86 are communicated with each other when the openings of the radial holes 32c overlap with the discharge chamber 86.

The oil pump 80 having the structure described above is driven by transmission of the rotation of the drive pinion shaft 32 that is the rear-wheel side rotating shaft. More specifically, a drive gear 87 is spline-engaged with the outer periphery of the drive pinion shaft 32, such that the drive gear 87 rotates together with the drive pinion shaft 32. The drive gear 87 is in mesh with a counter gear 88 that is integrally formed with the counter shaft 84 of the oil pump 80. The drive gear 87 and the counter gear 88 are housed in an internal space 23a formed inside the differential carrier 23. It should be noted that the counter gear 88 may also be integrally attached to the counter shaft 84 by spline-engagement.

Also, when the drive pinion shaft 32 rotates, this rotation is transmitted via the drive gear 87 and the counter gear 88, such that the counter shaft 84 and the inner rotor 81 rotate together. When this happens, the inner rotor 81 and the outer rotor 82 rotate relative to each other, such that the inter-teeth volume of the inner rotor 81 and the outer rotor 82 changes. With this change, hydraulic fluid is drawn into the intake chamber 85 from the oil circulation path. The hydraulic fluid that has flowed into the intake chamber 85 is delivered to the discharge chamber 86 side, and discharged into the oil circulation path from the discharge chamber 86.

When this kind of oil pump 80 is driven, hydraulic fluid is circulated to an oil circulation path formed inside the electronically controlled coupling 30. The oil circulation path in the electronically controlled coupling 30 is a path that leads, for example, from the discharge chamber 86 of the oil pump 80→the radial hole 32c and the axial hole 32b of the drive pinion shaft 32→the internal space 40a of the inner shaft 40→the space C3 between the inner shaft 40 and the front housing 33→the clutch mechanism housing chamber C2→the communication holes 37a in the front housing 33→the space C4 between the front housing 33 and the cover 31→the communication hole 31c and the oil reservoir 31b of the cover 31→the bottom portion 35 of the oil pump 80. The seal rings (such as the O-ring and X-ring) 47, 48, 91, and 92 and the oil seals 38b, 93, 94, and 95 are provided in appropriate locations in the electronically controlled coupling 30 so that the hydraulic fluid in the oil circulation path will not get into the electromagnet housing chamber C1 and the differential carrier 23, or leak out from the cover 31.

Also, the hydraulic fluid that circulates through the oil circulation path is supplied to the clutch mechanism portion CL1 (i.e., the pilot clutch 61 and the main clutch 71) that is arranged in the clutch mechanism housing chamber C2. In this case, hydraulic fluid that is not used for engaging the clutch mechanism portion CL1 is supplied to the clutch mechanism portion CL1 by driving the oil pump 80. Here, the pilot clutch 61 and the main clutch 71 of the clutch mechanism portion CL1 are engaged by the viscous resistance of the hydraulic fluid, and the hydraulic fluid that is forcibly circulated through the oil circulation path inside of the electronically controlled coupling 30 by the oil pump 80 without contributing much at all to that engagement is the “hydraulic fluid not used for engaging.”

According to this example embodiment, when the vehicle is towed with only the rear wheels 19 contacting the ground and the engine 10 stopped, a difference in rotation speed occurs between the propeller shaft 16 and the drive pinion shaft 32. In this case, hydraulic fluid that is not used for engaging the clutch mechanism portion CL1 is supplied to the clutch mechanism portion CL1 by the pumping action of the oil pump 80 that is created when the drive pinion shaft 32 rotates, which differs from the related art. Therefore, when the drive pinion shaft 32 rotates at times such as when the vehicle is being towed, for example, the pilot clutch 61 and the main clutch 71 of the clutch mechanism portion CL1 are able to be lubricated and cooled by the hydraulic fluid supplied by the oil pump 80.

When the vehicle is being towed, even if the clutch mechanism portion CL1 is not engaged (i.e., even if the electromagnet 51 of the electronically controlled coupling 30 is de-energized), the pilot clutch 61 and the main clutch 71 of the clutch mechanism portion CL1 are in a so-called partially engaged state due to the viscous resistance (i.e., drag resistance) of the hydraulic fluid, which may result in the temperature of the clutch mechanism portion CL1 increasing. However, in this example embodiment, when the drive pinion shaft 32 is rotating, the pilot clutch 61 and the main clutch 71 of the clutch mechanism portion CL1 can be efficiently cooled by the hydraulic fluid being forcibly circulated through the oil circulation path, so an increase in the temperature of the clutch mechanism portion CL1 can be inhibited.

Also, in this example embodiment, the oil pump 80 is mounted on the counter shaft 84 that is provided parallel to the drive pinion shaft 32. More specifically, the drive shaft that drives the inner rotor 81 of the oil pump 80 is the counter shaft 84. That is, the oil pump 80 is not driven directly by the drive pinion shaft 32. Instead, the rotation of the drive pinion shaft 32 is transmitted to the inner rotor 81 via the counter shaft 84 to drive the oil pump 80. Therefore, the oil pump 80 can be driven, even if no electric power is supplied, when the drive pinion shaft 32 rotates. Also, the degree of freedom with respect to the location where the oil pump 80 is arranged can also be improved.

Furthermore, in this example embodiment, the oil pump 80 is mounted on the cover 31 that is a non-rotating portion of the electronically controlled coupling 30. More specifically, the outer rotor 82 of the oil pump 80 is housed inside the pump housing 83 that is integrally fixed to the cover 31. Therefore, when the drive pinion shaft 32 that is the rear-wheel side rotating shaft rotates, a difference in rotation speed occurs between the drive pinion shaft 32 and the cover 31, so the oil pump 80 is driven regardless of a difference in rotation speed between the propeller shaft 16 that is the front-wheel side rotating shaft and the drive pinion shaft 32. As a result, when the drive pinion shaft 32 rotates, the oil pump 80 is always driven, so the clutch mechanism portion CL1 can always be lubricated and cooled.

Also, in this example embodiment, the oil pump 80 is provided between the electronically controlled coupling 30 and the rear differential 17. As a result, heat exchange can be performed between the electronically controlled coupling 30 and the rear differential 17 by the hydraulic fluid that is forcibly circulated through the oil circulation path when the drive pinion shaft 32 rotates. Also, when the vehicle is being towed, cooling of the pilot clutch 61 and the main clutch 71 of the clutch mechanism portion CL1 can be promoted, so an increase in the temperature of the clutch mechanism portion CL1 can be more effectively suppressed.

The invention is not limited to only the example embodiments described above. That is, the invention is intended to include all applications and modifications that are within the scope of the claims for patent and a scope equivalent to that scope. Several examples are described below.

In the example embodiment described above, the oil pump 80 is mounted on the counter shaft 84, but the oil pump 80 may also be assembled to the drive pinion shaft 32 that is the rear-wheel side rotating shaft. In this case, the drive shaft that drives the inner rotor 81 of the oil pump 80 is the drive pinion shaft 32. As a result, the oil pump 80 is directly driven by the rotation of the drive pinion shaft 32, even if electric power is not supplied, so there is no longer a need to newly provide a rotating member such as the counter shaft 84 of the example embodiment described above, thereby enabling the structure to be simplified.

Also, in the example embodiment described above, the oil pump 80 is mounted on the cover 31 that is a non-rotating portion of the electronically controlled coupling 30, but the oil pump 80 may also be mounted in another location as long as it is a location where a difference in rotation speed can occur with the drive pinion shaft 32 that is the rear-wheel side rotating shaft. For example, the oil pump 80 may be mounted on a portion that rotates together with the propeller shaft 16 that is the front-wheel side rotating shaft. In this case, the oil pump 80 will be driven if a difference in rotation speed occurs between the propeller shaft 16 and the drive pinion shaft 32 when the drive pinion shaft 32 rotates. In this case, the discharge amount of the oil pump 80 is determined according to the difference in rotation speed between the propeller shaft 16 and the drive pinion shaft 32, so an excessive supply of hydraulic fluid to the clutch mechanism portion CL1 can be suppressed when the difference in rotation speed between the propeller shaft 16 and the drive pinion shaft 32 is small.

Further, in the example embodiment described above, the oil pump 80 is arranged between the electronically controlled coupling 30 and the rear differential 17, but the oil pump 80 may also be arranged in another location.

Also, in the example embodiment described above, the electronically controlled coupling 30 is arranged between the propeller shaft 16 and the drive pinion shaft 32, but the electronically controlled coupling 30 may also be arranged in another locations as long as it is a location where the driving force from the driving source can be transmitted to the rear wheels 19 by engaging the clutch mechanism portion CL1. In other words, the front-wheel side rotating shaft may be a shaft other than the propeller shaft 16. Alternatively, the rear-wheel side rotating shaft may be a shaft other than the drive pinion shaft 32. For example, the front-wheel side rotating shaft may be the front propeller shaft, the rear-wheel side rotating shaft may be the rear propeller shaft, and the coupling device may be arranged between the front propeller shaft and the rear propeller shaft.

Moreover, in the example embodiment described above, the trochoid oil pump 30 is given as an example of the oil pump, but the oil pump may have another structure as long as it is driven when the rear-wheel side rotating shaft rotates. Also, in the example embodiment described above, the electronically controlled coupling 30 is given as an example of the coupling device, but the coupling device may have another structure as long as it includes a wet type frictional engagement portion.

Further, in the example embodiment described above, the invention is applied to a four-wheel-drive vehicle with a front-wheel-drive base, but the invention may also be applied to a four-wheel-drive vehicle with a rear-wheel-drive base.

The invention may be applied to a coupling device that is provided with a wet type frictional engagement portion that engages by viscous resistance of hydraulic fluid and that is configured to be able to transmit driving force from a driving source to a rear-wheel side rotating shaft by engagement of the wet type frictional engagement portion.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the scope of the invention.

What is claimed is:

1. A coupling device comprising:
a wet type frictional engagement portion that is provided between a front-wheel side rotating shaft and a rear-wheel side rotating shaft, and that engages by viscous resistance of hydraulic fluid, and transmits driving force from a driving source to the rear-wheel side rotating shaft by this engagement; and
an oil pump that supplies hydraulic fluid not used for engaging the wet type frictional engagement portion to the wet type frictional engagement portion when the rear-wheel side rotating shaft rotates.

2. The coupling device according to claim 1, wherein the oil pump is mounted on the rear-wheel side rotating shaft.

3. The coupling device according to claim 2, wherein the oil pump is mounted on a non-rotating portion of the coupling device.

4. The coupling device according to claim 2, wherein the oil pump is arranged between the coupling device and a differential device that performs a differential operation between a pair of left and right rear wheels.

5. The coupling device according to claim 2, wherein the oil pump is a trochoid oil pump that creates a pumping action by relative rotation of an inner rotor and an outer rotor.

6. The coupling device according to claim 1, wherein a gear provided on the rear-wheel side rotating shaft is in mesh with a gear provided on a counter shaft that is arranged parallel to the rear-wheel side rotating shaft, and the oil pump is mounted on the counter shaft.

7. The coupling device according to claim 6, wherein the oil pump is mounted on a non-rotating portion of the coupling device.

8. The coupling device according to claim 6, wherein the oil pump is arranged between the coupling device and a differential device that performs a differential operation between a pair of left and right rear wheels.

9. The coupling device according to claim 6, wherein the oil pump is a trochoid oil pump that creates a pumping action by relative rotation of an inner rotor and an outer rotor.

10. The coupling device according to claim 1, wherein the oil pump is mounted on a non-rotating portion of the coupling device.

11. The coupling device according to claim 1, wherein the oil pump is arranged between the coupling device and a differential device that performs a differential operation between a pair of left and right rear wheels.

12. The coupling device according to claim 1, wherein the oil pump is a trochoid oil pump that creates a pumping action by relative rotation of an inner rotor and an outer rotor.
